(19) United States
(12) Patent Application Publication
(10) Pub. No.: US 2007/0145715 A1
(43) Pub. Date: Jun. 28, 2007

(54) Trailer Tongue Comprising Rapid Telescoping and Pivotal Adjustment Mechanisms

(76) Inventor: Richard Zimmerman, Palm Bay, FL (US)

Correspondence Address: John L. DeAngelis, Jr. Esquire;Beusse Wolter Sanks Mora & Maire, P.A., Suite 2500, 390 North Orange Avenue, Orlando, FL, 32801, US

(21) Appl. No.: 11/615,071

(22) Filed: Dec. 22, 2006

Related U.S. Application Data
(60) Provisional application No. 60/753,121, filed on Dec. 22, 2005.
(60) Provisional application No. 60/786,315, filed on Mar. 27, 2006.

(51) Int. Cl. B60D 1/40

(52) U.S. Cl. 280/478.1

(57) ABSTRACT

In one embodiment the invention comprises a trailer hitch comprising: a frame having a front, a telescoping member slidably supported by the frame for telescoping from the frame front and wherein the telescoping member is movable laterally relative to the frame.

This patent application claims the benefit of the provisional patent application filed on Dec. 22, 2005 assigned application No. 60/753,121 and the provisional patent application filed on Mar. 27, 2006 assigned application No. 60/786,315.

### FIELD OF INVENTION

The present inventions relates generally to trailer tongue assemblies and more particularly to a trailer tongue comprising telescoping and pivoting mechanisms that simplify the process of connecting the trailer to the towing vehicle.

### BACKGROUND OF INVENTION

Trailers are used to tow boats, campers, recreational vehicles and work equipment. Generally the trailer is connected to a towing vehicle, such as a car, pickup truck or sports utility vehicle, by a trailer tongue extending from the trailer. The tongue further comprises a trailer ball receptacle that couples to a tow hitch ball on the vehicle. With the trailer and towing vehicle firmly coupled, the trailer can be easily and safely towed.

Hitches are characteristically mounted with the tow hitch ball very close to the vehicle frame. The vehicle must, therefore, necessarily be backed very close to and in precise alignment with the trailer tongue to effect proper coupling of the trailer to the vehicle hitch. If perfect alignment is not achieved during the alignment operation, the vehicle is frequently damaged when the trailer tongue strikes the vehicle. Unless the tow hitch ball is in perfect alignment with the trailer ball receptacle, the receptacle will not lock positively onto the ball and extensive additional maneuvering of the vehicle is necessary to engage the ball and the ball receptacle. If a trailer does not impose substantial weight on the tongue, the driver may be able to manually pull the trailer tongue to one side or the other until it is over the tow hitch ball on the vehicle. However, if the trailer hitch cannot be manually moved, the driver must resort to positioning and repositioning the vehicle until the trailer tongue ball receptacle is aligned with the hitch ball.

Hence, there is a need for a new and improved trailer tongue assembly that overcomes one or more of the drawbacks identified above.

### BRIEF DESCRIPTION OF THE INVENTION

One embodiment of the invention comprises a trailer hitch comprising: a frame having a front, a telescoping member slidably supported by the frame for telescoping from the frame front and wherein the telescoping member is movable laterally relative to the frame.

Another embodiment of the invention comprises a method for attaching a trailer hitch to a towing vehicle, comprising: moving a trailer attachment mechanism on the towing vehicle proximate the trailer hitch, telescopically extending and laterally moving a member of the trailer hitch to mate with the attachment mechanism, attaching the trailer hitch to the attachment mechanism and locking the trailer hitch from telescopic and lateral movement

### BRIEF DESCRIPTION OF THE FIGURES

The present invention can be more easily understood and the advantages and uses thereof more readily apparent when the following detailed description of the present invention is read in conjunction with the figures wherein:

FIG. 1 is a top view of a portion of a trailer frame including a trailer tongue telescoping extension and pivotal trailer tongue of the present invention.

FIGS. 2A and 2B are top views of respective upper and lower front members or mounting plates of the trailer frame of FIG. 1.

FIG. 3 is a top view of a portion of the trailer frame including a first configuration of the trailer tongue telescoping extension and pivotal trailer tongue of the present invention.

FIG. 4 is a perspective side view of a bolt/nut for use with one embodiment of the present invention.

FIG. 5 is a top view of the trailer frame including a second configuration of the trailer tongue telescoping extension and pivotal trailer tongue of the present invention.

FIGS. 6-8 are side views of the trailer tongue telescoping extension and a front portion of the trailer tongue according to different configurations for the illustrated elements.

FIG. 9 is a front view of a spring lock pin component of the present invention.

FIGS. 10-12 are top views of a rear portion of the trailer tongue assembly according to different configurations of the presented components of the invention.

FIGS. 13A and 13B are top views of respective upper and lower rear members or mounting plates of the trailer frame of FIG. 1.

FIG. 13C is a top view of a support plate component of the present invention.

FIG. 14 is a front view of a spring lock pin component of the present invention.

FIG. 15 is a side view of the rear portion of the trailer tongue of the present invention.

FIG. 16 is a perspective view of one configuration of the trailer tongue and trailer tongue telescoping extension of the invention.

FIGS. 17 and 18 are front views of different configurations of a spring lock mechanism of the present invention.

FIG. 19 is a perspective view of a trailer tongue telescoping extension partially inserted into a portion of the trailer tongue.

FIG. 20 is a perspective view of the trailer tongue telescoping extension fully inserted into a trailer tongue.

FIG. 21 is a view of components for attaching the mechanism of the present invention to an existing trailer frame.

FIG. 22 is a schematic side view of the trailer frame assembly of the present invention attached to an existing trailer frame.

In accordance with common practice, the various described features are not drawn to scale, but are drawn to emphasize specific features relevant to the invention. Like reference characters denote like elements throughout the figures and text.

### DETAILED DESCRIPTION OF THE INVENTION

Before describing in detail exemplary structures and methods related to a trailer tongue according to the teachings of the present inventions, it should be observed that the present inventions resides primarily in a novel and non-obvious combination of elements and process steps. So as not to obscure the disclosure with details that will be readily apparent to those skilled in the art, certain conventional elements and steps have been presented with lesser detail, while the drawings and the specification describe other elements and steps pertinent to understanding the invention in greater detail.

The following embodiments are not intended to define limits as to the structures or methods of the inventions, but only to provide exemplary constructions. The embodiments are permissive rather than mandatory and illustrative rather than exhaustive.

The invention provides a new, non-obvious and improved trailer tongue with telescoping, pivotal and rapid adjustment features. Accordingly, the present invention provides a new and more convenient coupling method for connecting the trailer tongue to the vehicle's tow hitch ball. To accomplish this connection, firstly the towing vehicle is driven rearward so the trailer tongue of the present invention is proximate the trailer hitch ball. Secondly, the receptacle on the end of the trailer tongue is rapidly and easily adjusted (laterally and telescopically) to engage the trailer hitch ball. The tongue bar of the invention pivots and telescopes to allow the trailer tongue receptacle to rotate laterally, left or right, and slide longitudinally or telescopically, forward or rearward, simultaneously, rapidly and easily, to engage the receptacle with the proximate hitch ball on the towing vehicle.

Note that moving the trailer tongue receptacle to the ball is the opposite of the typical situation where the vehicle is positioned and repositioned to align the trailer tongue ball receptacle to the vehicle hitch ball. Thirdly the receptacle and the ball are latched together in the conventional manner. Thus the trailer is connected, although flexibly so, to the towing vehicle. Fourthly, the trailer tongue assembly of the present invention is restored to a locked position by maneuvering the towing vehicle rearward then forward to allow spring loaded lock pins to drop into their respective mating holes, locking the trailer tongue bar against lateral and telescoping movement during towing.

Thus the present invention provides a trailer tongue bar that permits simultaneous adjustment of the trailer tongue ball receptacle along two axes, i.e., the lateral and the longitudinal directions. The trailer tongue bar comprises a support member that is telescopically received within a hollow receiver and can farther be adjusted laterally for easy coupling to the proximate towing vehicle. The trailer tongue bar also assumes a fixed locked configuration for towing. This is accomplished by providing a lock member, such as a first pin to restrain the hitch from moving laterally, left or right, and by providing a second pin to additionally restrain the hitch from moving telescopically Longitudinally) forward or rearward during the towing.

Since the trailer ball receptacle can be extended (telescoped) and retracted, forward or rearward in a longitudinal direction as well as pivoted laterally left or right, problems of trailer/vehicle misalignment during the coupling process are minimized.

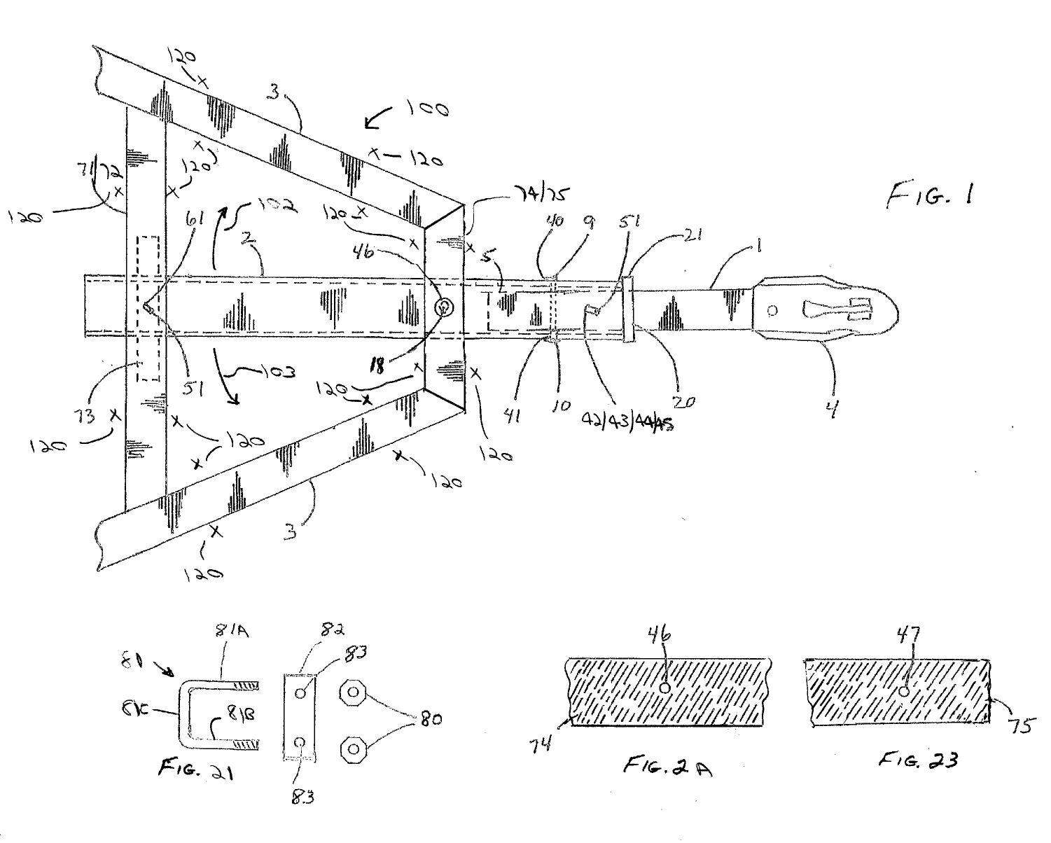

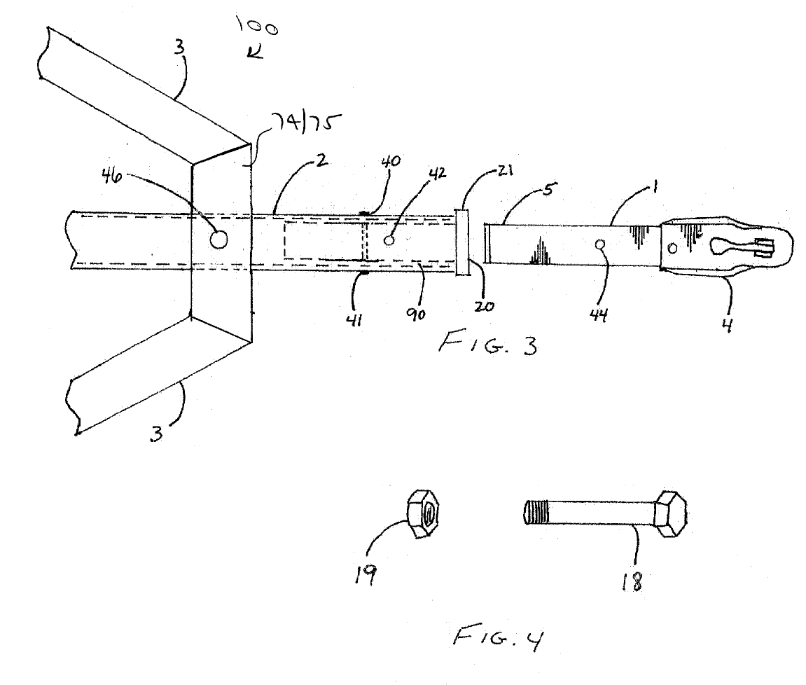

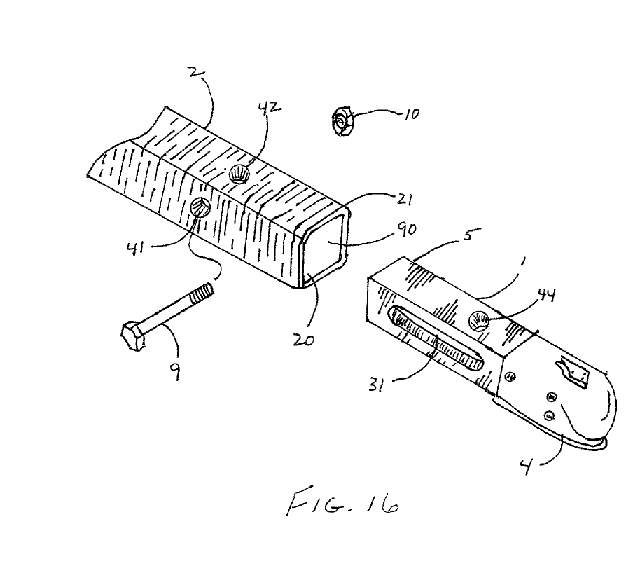

FIG. 1 is a top view illustrating a locked or towing configuration of a first embodiment of the present invention. A trailer frame 100 comprises side members 3, upper and lower rear members 71/72, also referred to as mounting plates, (see also FIGS. 13A and 13B) and upper and lower front members 74/75, also referred to as mounting plates, (see also FIGS. 2A and 2B). Only the upper members 71 and 74 are shown in FIG. 1, the lower members 72 and 75 are aligned with the respective upper members 71 and 74 and are therefore hidden from view in FIG. 1. In the FIG. 1 embodiment the side members 3 and the front members 74/75 are configured to resemble a U-shape, with the rear members closing the mouth of the U.

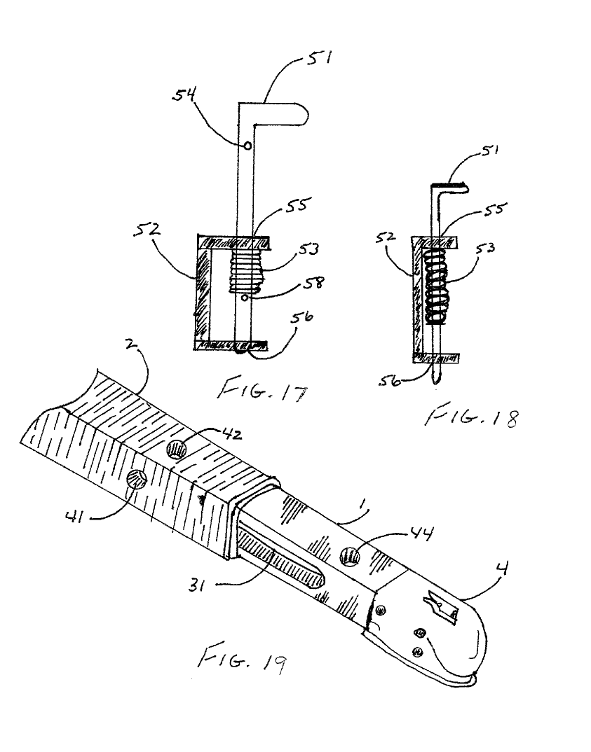

The telescoping and pivotal trailer tongue of the present inventions comprises a tubular (having a rectangular or circular cross-section) pivotal trailer tongue 2 movably connected to the front members 74/75 by a bolt 18 passing though a hole 46 in the member 74 and a hole 47 in the member 75. See FIGS. 2A and 2B. A nut 19 (not shown in FIG. 1) mates with the bolt 18 to movably attach the trailer tongue 2 (and a telescoping trailer tongue extension 1) to the frame 100. See also FIG. 4, which illustrates an embodiment of the threaded bolt 18 and mating nut 19 for attaching the tongue 2/extension 1 to the frame 100. The threaded bolt 18 is inserted into and through aligned holes 46 in the upper front member 74, a hole 48 (see FIG. 15) in a top surface of the pivotal trailer tongue 2, a hole 49 (see FIG. 15) in a bottom surface of the pivotal trailer tongue 2 and hole 47 in the lower front member 75. The bolt 18 is secured in a locked configuration with the nut 19, while allowing the pivotal trailer tongue 2 to pivot laterally left or right about the bolt 18/nut 19 relative to the trailer frame 100.

The telescoping trailer tongue extension 1 comprises a trailer tongue ball receptacle 4 welded or otherwise securely attached thereto. A locking pin 51, described in more detail below, passes through aligned holes 42 and 43 in the tongue 2 and 44 and 45 in the tongue extension 1 to secure the extension 1 relative to the trailer tongue 2 and thereby prevent telescoping action.

The trailer tongue telescoping extension 1 comprises an end 5 received within an opening 20 of the pivotal trailer tongue 2. The opening 20 is dimensioned to slidably receive the end 5 of the trailer tongue extension 1 to allow the tongue extension 1 to move or telescope freely along a longitudinal axis relative to the trailer tongue 2. In one embodiment, an end piece or sleeve 21 is welded or otherwise securely attached to the opening 20 to protect edge surfaces of the opening 20 from damage caused by forward or rearward telescoping motion of the trailer tongue telescoping extension 1.

FIG. 2A shows a portion of the upper front member 74 (and the hole 46) of the frame 100. In one embodiment the member 74 is welded or otherwise securely attached by other techniques between the side members 3 of the frame 100.

FIG. 2B shows a portion of the lower front member 75 (and the hole 47) of the frame 100. In one embodiment the member 75 is welded or otherwise securely attached by other techniques between the side members 3 of the frame 100.

FIG. 3 shows a top view of a portion of the frame 100, a portion of the pivotal trailer tongue 2 and the trailer tongue telescoping extension 1 in a separated configuration.

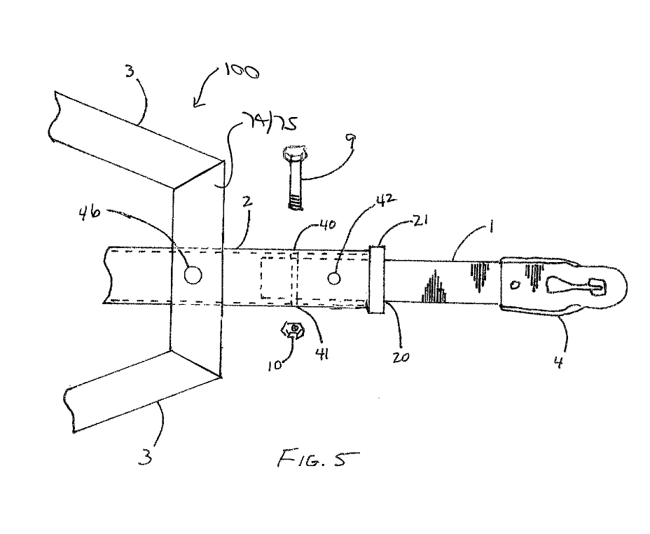

FIG. 5 illustrates the end 5 of the extension 1 fully inserted into the opening 20 of the pivotal trailer tongue 2. A threaded bolt 9 is inserted into and through cooperating holes 40 and 41 in spaced-apart side surfaces of the tongue 2 and through a slot 31 in the extension 1 (see also FIG. 6). The bolt 9 is secured by a nut 10 (see FIG. 5), but the trailer tongue telescoping extension 1 slides forward or rearward along a longitudinal axis as governed by movement of the slot 31 relative to the bolt 9.

The side view of FIG. 6 shows a front portion of the pivotal trailer tongue 2 separated from the telescoping extension 1, further illustrating a lock assembly for locking the tongue 2 relative to the extension 1. A lock assembly bracket 52, (see also FIG. 9) is welded or otherwise securely attached to the top surface of the pivotal trailer tongue 2. The locking pin 51 is aligned with holes 42 and 43 formed in the respective top and bottom surfaces of the pivotal trailer tongue 2 (see also FIG. 8), holes 44 and 45 formed in the respective top and bottom surfaces of the extension 1 (see FIG. 19) and holes 55 and 56 of the bracket 52 (see FIG. 9).

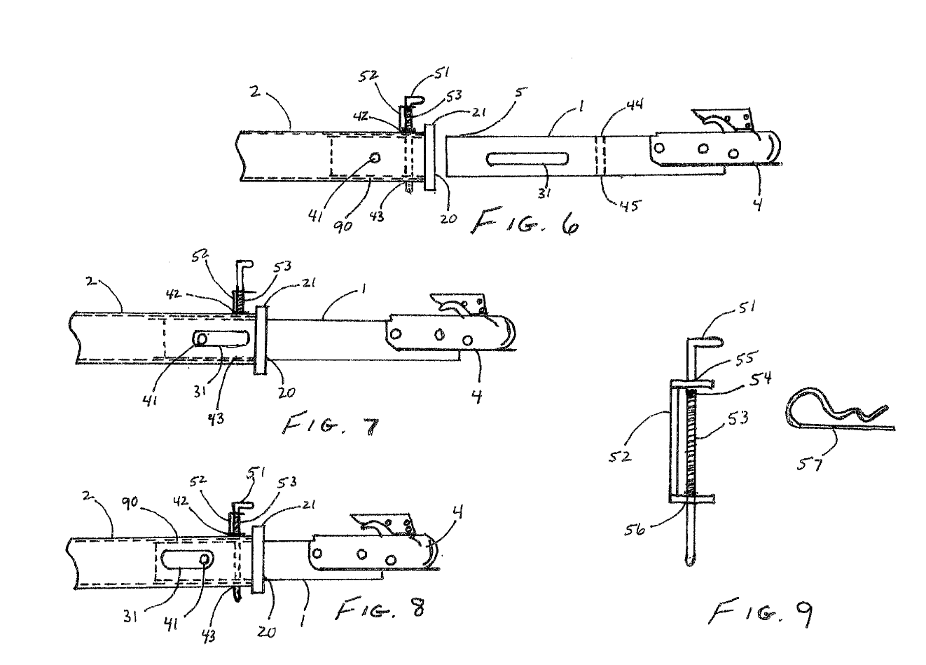

FIG. 7 illustrates a configuration of the invention with the trailer tongue telescoping extension 1 in a “free” or unlocked position. The lock pin 51 is in the retracted position (see FIG. 17, where a spring 53 is in a compressed state) allowing the trailer tongue telescoping extension 1 to be extended forward and rearward telescopically relative to the pivotal trailer tongue 2. As the trailer tongue telescoping extension 1 is extended forward or rearward, it slides freely within the trailer tongue 2 as the bolt 9 travels freely within the slot 31 of FIG. 6 until the extension 1 reaches the desired position relative to the vehicle's tow hitch ball. The trailer tongue telescoping extension 1 ball receptacle 4 can then be attached to the vehicle hitch ball (not shown) in the normal manner.

FIG. 8 illustrates a “locked” configuration of the present invention where the trailer tongue telescoping extension 1 is locked relative to the pivotal trailer tongue 2. In this configuration, the spring 53 is fully extended driving the lock pin 51 through aligned holes 42 and 43 of the tongue 2 and 44 and 45 of the extension 1. The lock pin automatically reverts to the locked configuration as the trailer tongue telescoping extension 1 is retracted in a rearward longitudinal direction by rearward movement of the vehicle, causing the holes 44 and 45 of the extension 1 to align with the holes 42 and 43 of the tongue 2, which in turn extends the spring 53 to drive the lock pin 51 through these aligned holes.

It can now be appreciated how the present invention simplifies the trailer coupling and locking process by referring especially to FIG. 7 and FIG. 8. Firstly, the trailer tongue telescoping extension 1 can be manually extended to the desired position and connected to the towing vehicle hitch ball as explained above. Secondly, the towing vehicle (not shown) can be driven slowly in a rearward direction, causing (due to trailer drag) the trailer tongue telescoping extension 1 to slide in a rearward direction into the pivotal trailer tongue 2 and the lock pin 51 to freely engage into the locked position when the appropriate holes in the tongue 2 and the extension 1 become aligned as described above, thereby locking the extension 1 relative to the tongue 2.

FIG. 9 shows a side view of the lock pin assembly comprising the lock pin 51, the bracket 52, the spring 53, a lock hole 54 and the holes 55 and 56 defined in the bracket 52. In one embodiment the lock hole 54 receives a cotter pin 57 to restrain the spring 53 in the locked condition, that is, preventing the lock pin 51 from vertical motion that would cause the pin 51 to disengage the extension 1 from the tongue 2, effectively disconnecting the towing vehicle from the trailer.

Returning to FIG. 1, the pivoting feature of the present invention is now described with reference to the upper and lower rear members 71/77 the frame 100. FIG. 10 illustrates a configuration of the present invention wherein the rear portion of the pivotal trailer tongue 2 is in a “free, full right position.” The pivotal trailer tongue 2 and support plate 73 (see FIG. 13C) ride freely between the upper and the lower rear members or mounting plates 71 (see FIG. 13A) and 72 (see FIG. 13B). The support plate 73 is welded or otherwise securely attached to the top of the rearward end of the pivotal trailer tongue 2, allowing the retracted lock pin 51 (and its associated components as illustrated in FIG. 9) to ride freely on a top surface of the support plate 73 as the pivotal trailer tongue 2 moves laterally within the frame 100 as indicated by arrowheads 102 and 103 in FIG. 1.

FIGS. 10-12 illustrate the tongue pivoting feature of the present invention. FIG. 11 illustrates the rear portion of the pivotal trailer tongue 2 in a “free full left position.” The pivotal trailer tongue 2 and support plate 73 assembly ride freely between the upper and the lower rear members or mounting plates 71 (see FIG. 13A) and 72 (see FIG. 13B). The support plate 73 is welded or otherwise securely attached to the top surface of the rearward end of the pivotal trailer tongue 2. The retracted lock pin 51 (and its associated components as illustrated in FIG. 9) to ride freely on a top surface of the support plate 73 as the pivotal trailer tongue 2 moves laterally within the frame 100 as indicated by the arrowheads 102 and 103 in FIG. 1.

Now it can be appreciated that manual movement of the pivotal trailer tongue 2 laterally left or right allows easy trailer-to-vehicle coupling when the towing vehicle with hitch ball (not shown) is not positioned sufficiently close or in precise alignment with the trailer tongue ball receptacle 4. It is only necessary for the vehicle to be relatively close to the trailer tongue 2, as the latter can be manually moved (laterally or telescopically) to mate with the trailer ball. However, although coupled the trailer is not yet suitable for road towing.

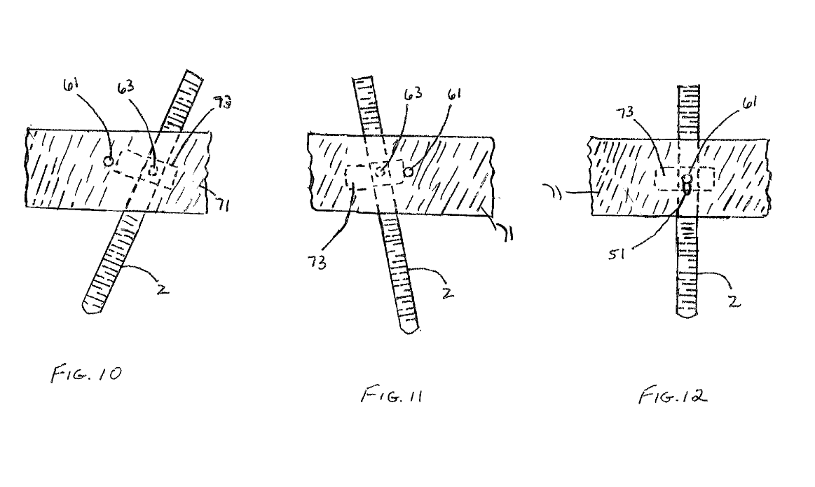

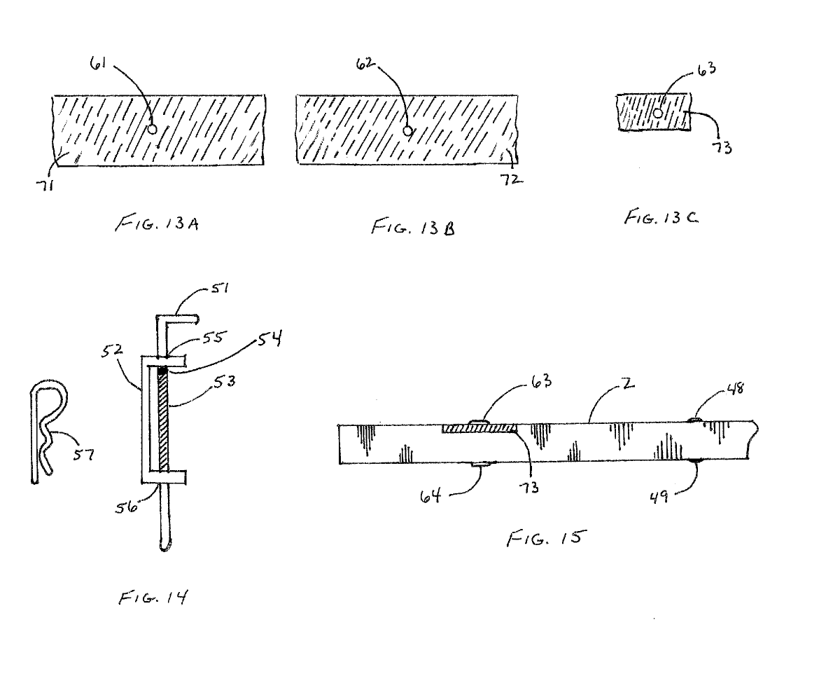

FIG. 12 illustrates a “locked center position” where the rear portion of the pivotal trailer tongue 2 is restrained from lateral movement by extension of the lock pin 51 in a downward direction when the tension of the spring 53 is released, allowing lock pin 51 to slide freely through holes 55 and 56 of the bracket 52, the hole 61 in the upper member 71 (see FIG. 13A), the hole 63 in the support plate 73 (see FIGS. 13C and 15), the hole 64 in a lower surface of the trailer tongue 2 (see FIG. 15) and the hole 62 in the lower member 72 (see FIG. 13B).

Referring to FIG. 10, FIG. 11 and FIG. 12, manually moving the pivotal trailer tongue 2 laterally left or right allows easy trailer to vehicle coupling when the towing vehicle with hitch ball (not shown) is not backed closely enough or in precise alignment with the trailer tongue ball receptacle 4. Once the trailer tongue ball receptacle 4 is attached securely to the towing vehicle hitch ball, the towing vehicle can be driven slowly forward, causing the pivotal trailer tongue 2 to move toward the locked center position due to trailer drag. As the pivotal trailer tongue moves toward the locked position, the lock pin 51 rides freely along the upper surface of the support plate 73. As it reaches the locked position holes 61, 62, 63 and 64 align allowing the biased spring 53 to extend driving the lock pin 51 down through the bracket 52 holes 55, and 56 and through the holes 61, 62, 63 and 64. Once in this locked position, a cotter pin 57 can be inserted into and through a hole 54 to securely lock the lock pin 51 in the extended position.

FIG. 13A shows a portion of the upper rear member 71 (and the hole 61) of the frame 100. In one embodiment the member 71 is welded or otherwise securely attached between the side members 3 of the frame 100 as illustrated in FIG. 1.

FIG. 13B shows a portion of the lower rear member 72 (and the hole 62) of the frame 100. In one embodiment the member 72 is welded or otherwise securely attached between the side members 3 of the frame 100 as illustrated in FIG. 1.

FIG. 13C shows the support plate 73 that is welded or otherwise securely attached to the top surface of the rear portion of the pivotal trailer tongue 2.

FIG. 14 illustrates the locking assembly that is welded or otherwise securely attached to a top surface of the upper rear member 71.

FIG. 15 shows a side view of the rear portion of the pivotal trailer tongue 2 and alignment holes 63, 64, 48 and 49. Also shown is a side view of the support plate 73 in an embodiment where the plate 73 is supported within a recess formed in the tongue 2. In another embodiment the plate 73 rests on a top surface of the tongue 2.

FIG. 16 shows a perspective view of the front portion of the pivotal trailer tongue 2 including the open end 20, the end piece or sleeve 21 and the mating end 5 of the trailer tongue telescoping extension 1. The mating end 5 is slip-fitted into the open end 20, thus allowing, as shown in FIG. 19, slot 31 to align with the holes 40 (not shown) and 41. Once alignment is achieved, the bolt 9 is inserted into and through holes 40 and 41 and the slot 31. The nut 10 is then placed on the bolt 9. With the slot 31 slightly oversized relative to the diameter of the bolt 9, forward and rearward telescoping movement of the trailer tongue extension 1 is allowed within the pivotal trailer tongue 2.

FIG. 17 shows the lock pin assembly comprising the lock pin 51, the bracket 52, and the spring 53 in a retracted position. When the lock pin 51 is manually pulled upwardly the spring 53 is compressed thus applying a slight force on an upper member of the bracket 52. As the lock pin 51 slides freely through holes 55 and 56 into the upward position, the lock pin 51 rides along the top surface of the trailer tongue telescoping extension 1 as shown in FIG. 19.

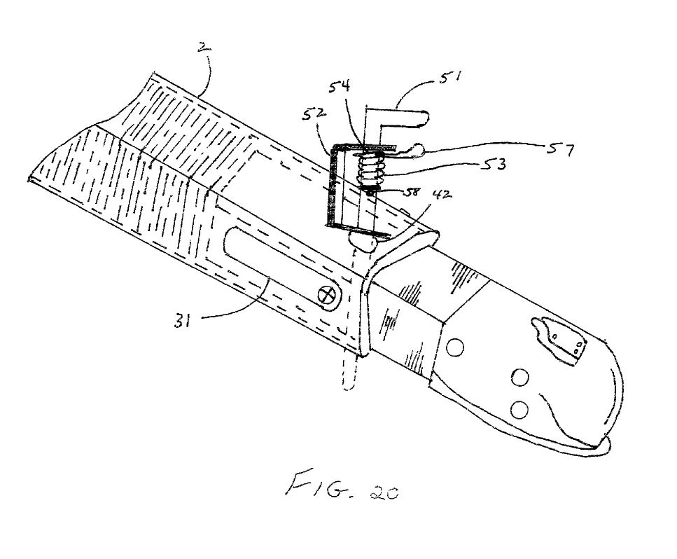

FIG. 18 shows the lock pin assembly comprising the lock pin 51, the bracket 52, and the spring 53 in the de-compressed configuration to allow the lock pin 51 to move freely in a downward position trough the holes 55 and 56, which will be inserted into the aligned holes 42 and 43 in the tongue 2 to lock telescoping extension 1 relative to the tongue 2.

FIG. 19 shows the trailer tongue telescoping extension 1 partially inserted into the open end 20 of the pivotal trailer tongue 2 in the extended or forward telescoping position to allow the trailer tongue ball receptacle 4 to be attached to the vehicle hitch ball (not shown).

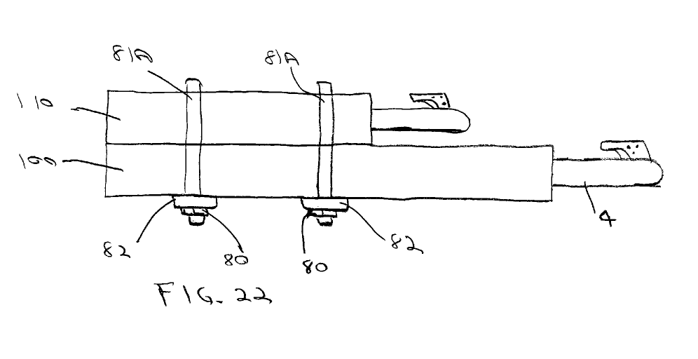

FIG. 20 illustrates the trailer tongue telescoping extension 1 fully inserted into the pivotal trailer tongue 2 in a locked position. When the vehicle (not shown) is driven slowly rearward (due to trailer drag), trailer tongue telescoping extension 1 is slid rearward into the pivotal trailer tongue 2. As slot 31 reaches the forward end of its track on bolt 9, holes 42, 43, 44 and 45 come into alignment, allowing the spring 53 to de-compress and the lock pin 51 to slide downwardly through the holes 55 and 56 of bracket 52 and through the holes 42, 43, 44 and 45 for locking the tongue 1. The cotter pin 57 can be slipped through the hole 54 to prevent unlocking during towing.

Now it can be appreciated that by manually moving the trailer tongue telescoping extension 1 in a forward or rearward telescoping direction, and the pivotal trailer tongue 2 in a laterally left or right direction, the trailer tongue receptacle ball 4 can easily be attached to the vehicle hitch ball and be ready for road tow as shown in FIG. 1.

FIG. 21 illustrates a threaded U-bolt 81, a plate 82 and mating nuts 80 for attaching the frame assembly 100 including related components as described above, to an existing trailer. The U-bolt comprises bolt side members 81A and 81B connected by a connecting member 81C.

Specifically the frame assembly 100 and the related components are placed in contact with the bottom or top surface of the existing trailer frame and affixed thereto by several U-bolts 81 disposed on the members 3, 71, 72, 74 and 75 such that the member spans the region between the bolt side members 81A and 81B. The bracket 82 is placed on the opposite side from the connecting member 81C, the holes 83 of the bracket 82 are received by the side members 81A and 81B and the bracket 82 is secured with the nuts 80. FIG. 22 is a schematic side view of the tongue section 110 of an existing trailer disposed above the frame assembly 100 of the present invention. One of the bolt side members 81A, the bracket 82 and one of the nuts 80 for two U-bolts 81 are illustrated. With reference to the top view of FIG. 1, “x” marks 120 indicate candidate locations for placement of the U-bolts 81 when the frame 100 is affixed to an existing trailer frame as illustrated in FIG. 22.

While various types of pins, having heads or bent ends have been shown by way of illustration in the illustrated embodiments, the inventor envisions other types and shapes of pins, keys and fasteners that provide equivalent functionality. While not shown for clarity, the inventor admonishes for safety, the use of pins and keys having locking action to prevent accidental removal of the pins, keys or fasteners due to towing motion and vibrations. These well-known locking actions include screws, nuts, cotter pins, spring pins, grasshopper pins, safety pins, spring-loaded ball locks and detents.

The various components of the frame 100 can be constructed from tubular, channel or right angle metal members. Those skilled in the art recognize that the choice of materials for the components depend on the trailer weight capacity.

While the embodiments of the present invention show the common trailer coupling hardware of hitch ball to female receiver cup, other conventional coupling methods would work equally well with the present invention. For instance, the latch over “pintle and ring” coupling could be easily incorporated into the present invention, as can be appreciated by those skilled in the art.

Although the various embodiments have been shown and described with respect to certain preferred embodiments, it is obvious that equivalent alterations and modifications will occur to others skilled in the art upon the reading and understanding of this specification and the annexed drawings. In particular regard to the various functions performed by the above described components (assemblies, members, devices, etc.), and the terms used to describe such components are intended to correspond, unless otherwise indicated, to any component that performs the specified function of the described component (i.e., that is functionally equivalent), even though not structurally equivalent to the disclosed structure that performs the function in the herein illustrated exemplary embodiments of the invention. In addition, while a particular feature of the invention may have been disclosed with respect to only one of the several embodiments, such feature may be combined with one or more other features of the other embodiments as may be desired and advantageous for any given or particular application.

What is claimed is:

1. A trailer hitch comprising:
a frame having a front;
a telescoping member slidably supported by the frame for telescoping from the frame front; and
wherein the telescoping member is movable laterally relative to the frame.

2. The trailer hitch of claim 1 wherein the telescoping member presents a telescoping configuration in which the telescoping member is slidable relative to the frame and a locked configuration in which the telescoping member is locked with respect to slidable movement relative to the frame.

3. The trailer hitch of claim 1 wherein the telescoping member presents a first configuration in which the telescoping member is laterally displaceable relative to the frame and a second configuration in which the telescoping member is locked with respect to lateral movement relative to the frame.

4. The trailer hitch of claim 1 wherein the frame comprises a receiving member, and wherein the telescoping member is slidably received within the receiving member.

5. The trailer hitch of claim 1 wherein the frame comprises two spaced apart leg members and a base member in a substantially U-shape, the frame further comprising a connecting member spanning the two leg members, and wherein a forward region of a receiving member is rotatably connected to the base member, the receiving member for slidably receiving the telescoping member, and wherein a rearward region of the receiving member is laterally movable between the two leg members.

6. The trailer hitch of claim 5 further comprising a first locking member having an unlocked configuration for permitting slidable motion of the telescoping member and a locked configuration for preventing slidable motion of the telescoping member relative to the receiving member, and a second locking member having an unlocked configuration in which the receiving member is laterally movable between the two leg members and having a locked configuration for preventing lateral motion of the receiving member between the two leg members.

7. The trailer hitch of claim 6 wherein the first locking member transitions from the unlocked to the locked configuration responsive to a predetermined orientation of the telescoping member relative to the receiving member.

8. The trailer hitch of claim 7 wherein the predetermined orientation comprises at least one opening in the telescoping member in alignment with an opening in the receiving member permitting the first locking member to attain the locked configuration.

9. The trailer hitch of claim 6 wherein the second locking member transitions from the unlocked to the locked configuration responsive to a predetermined orientation of the connecting bar relative to the receiving member.

10. The trailer hitch of claim 9 wherein the predetermined orientation comprises at least one opening in the connecting bar in alignment with an opening in the receiving member permitting the second locking member to attain the locked configuration.

11. The trailer hitch of claim 1 wherein the telescoping member defines a slot therein, and wherein the receiving member defines two opposing holes therein, wherein a holding member passes through the two holes and the slot to constrain movement of the telescoping member relative to the receiving member.

12. The trailer hitch of claim 1 further comprising a receiving member for telescopically receiving the telescoping member, the receiving member pivotably affixed to the frame to allow lateral motion of the receiving member relative to the frame.

13. The trailer hitch of claim 12 further comprising a plate supported by the receiving member at a rear region of the receiving member, a locking member supported by the frame having a first configuration wherein the locking member sets on a top surface of the plate and the receiving member is laterally movable relative to the frame, the locking member having a second configuration wherein the locking member interacts with the plate to prevent lateral motion of the receiving member relative to the frame.

14. The trailer hitch of claim 13 wherein in the second configuration the locking member extends into a hole defined in the plate to prevent lateral motion of the receiving member relative to the frame.

15. The trailer hitch of claim 14 wherein the locking member further comprises a member for preventing the locking member from reverting from the second configuration to the first configuration.

16. The trailer hitch of claim 1 further comprising an attachment mechanism for affixing the trailer hitch to an existing trailer.

17. A trailer hitch comprising:
a frame having spaced apart side members and front and rear members connecting front and rear regions of the side members;
a receiving member rotatably connected to the front member;
a telescoping member slidably supported within the receiving member, wherein the telescoping member presents a telescoping configuration in which the telescoping member is slidable relative to the receiving member and a locked configuration in which the telescoping member is locked with respect to slidable movement relative to the receiving member; and
the receiving member laterally displaceable between the side members while rotating about the rotatable connection, wherein the receiving member presents a first configuration in which the receiving member is laterally displaceable between the side members and a second configuration in which the receiving member is locked with respect to lateral displacement between the side members.

18. A method for attaching a trailer hitch to a towing vehicle, comprising:
moving a trailer attachment mechanism on the towing vehicle proximate the trailer hitch;
telescopically extending and laterally moving a member of the trailer hitch to mate with the attachment mechanism;
attaching the trailer hitch to the attachment mechanism; and
locking the trailer hitch from telescopic and lateral movement.
